(19) United States
(12) Patent Application Publication
(10) Pub. No.: US 2002/0120356 A1
(43) Pub. Date: Aug. 29, 2002

(54) Container designing system, container designing method, container designing program and recording medium for recording container designing program

(76) Inventors: Keiichi Takahashi, Nishinomiya-shi (JP); Michio Saito, Nishinomiya-shi (JP); Yoshihiko Nakamura, Hamamatsu-shi (JP); Shugo Usami, Hamamatsu-shi (JP)

Correspondence Address: HARNESS, DICKEY & PIERCE, P.L.C., P.O. BOX 828, BLOOMFIELD HILLS, MI, 48303, US

(21) Appl. No.: 09/938,145

(22) Filed: Aug. 23, 2001

(30) Foreign Application Priority Data
Feb. 26, 2001 (JP) 2001-050401

(51) Int. Cl. G06F 19/00

(52) U.S. Cl. 700/98

(57) ABSTRACT

A container designing system comprises a parametric inputting means for inputting a parametrically defined shape condition, a storing means for storing a shape condition, a solid model defining means for defining a three-dimensional outer shape of a hollow container as a solid model filled up with contents on the basis of the shape condition, and a solid model editing means for subjecting the solid model to a secondary processing.

### BACKGROUND OF THE INVENTION

1. Field of the Invention

The present invention relates to a container designing system, a container designing method, a container designing program and a recording medium for recording the container designing program, for designing an outer shape of a container such as a glass bottle, a can, a synthetic resin container or the like.

2. Description of Related Art

The design of a hollow container such as a glass bottle, a can, a synthetic resin container, for example, a polyethyleneterephthalate (PET) resin bottle, or the like has been performed hitherto by using a computer aided design (CAD) program operating on a computer.

A conventionally used CAD is capable of processing a three-dimensional (3D) treatment, and a wire frame model has been used for a three-dimensional structure defining technique. The wire frame model is used for defining a three-dimensional structure by means of dots and lines only. Since defining with the dots and lines, it is possible to carry forward a design of an outer shape under the condition that an internal structure of a model is seen through.

Other model for defining an outer shape can be a surface model. The surface model is used for defining a surface at a portion surrounded by lines of a wire frame model. In the surface model, a curved surface is represented by rounding an edge of two adjacent planes so that the adjacent planes are smoothly connected to each other or by emphasizing the edge of the two planes. Note that, since the curved surface is formed by connecting planes, it is defined as a hollow model.

An outer shape of a container is first defined by means of these conventional wire frame model or surface model, and then, as the need arises, the finished model is subjected to a secondary processing such as a modification and alteration for altering the outer shape or for supplementing some components, thus determining the outer shape of a container. In conclusion, after verifying whether the container model subjected to a secondary processing satisfies the requirements of a container capacity, a center of gravity, a tipping angle or the like, the outer shape is fixed. The wire frame model and the surface model are, in the characters of their models, such structured that an interior structure is defined and subjected to a secondary processing simultaneously with the outer shape designing, so that the wire frame model and the surface model are suitable for the hollow container designing.

In the conventional model using a wire frame, however, it is difficult to precisely represent a plane forming an outer shape by means of only the dots and lines, and therefore when previewing a container on a computer screen, it is difficult to smoothly represent an outer shape, accordingly, it has limitations by itself in a view of faithfully reproducing a container. Meanwhile, since not all the curved surface is defined by means of only the dots and lines, an error will occur in a calculation of a container capacity, a center of gravity, a tipping angle or the like.

As is different from a wire frame model, a surface model defines all of the planes, so that it is possible to faithfully perform a container preview on a computer screen or a calculation of a container capacity, a center of gravity, a tipping angle or the like. However, since the model is only defined by means of connecting planes, the processing is performed including the interior information, which follows the calculation of a container capacity, a center of gravity, a tipping angle or the like to be complicated and to require a lot of time. Meanwhile, for example, when a Boolean operation for calculating a logical sum (OR), a logical difference (XOR) or a logical product (AND) is applied in a secondary processing, an opening portion will be left in a take out portion by the Boolean operation. Owing to this, it is needed to subject to a treatment for closing the opening portion, thus complicating a secondary processing. Also, it is impossible due to lack of data to calculate a container capacity, a center of gravity, a tipping angle or the like provided that the opening portion closing treatment is not performed. As explained in the above, it is complicated to subject a surface model to a secondary processing, and also it will require a lot of time for generating an outer shape.

### SUMMARY OF THE INVENTION

In view of overcoming the foregoing problem, it is the object of the present invention to provide a container designing system, a container designing method, a container designing program and a recording medium for recording a container designing program, capable of faithfully reproducing a container upon smoothly representing an outer shape, capable of performing high-speed calculation of a container capacity, a center of gravity, a tipping angle or the like without treating the interior of the container, capable of performing a secondary processing to an outer shape with a higher efficiency and a higher speed, and capable of designing a varied outer shape.

In the present invention, a container capacity means a capacity that is a volume where a headspace capacity is subtracted from an over flow capacity of the hollow container. And also, a plane means both a flat surface and a curved surface.

A container designing system as set forth in claim 1 comprises a parametric inputting means for inputting a parametrically defined shape condition, a storing means for storing a shape condition, a solid model defining means for defining a three-dimensional outer shape of a hollow container as a solid model filled up with contents on the basis of the shape condition, and a solid model editing means for subjecting the solid model to a secondary processing.

According to the invention, since the outer shape of the container is defined as a solid model, when previewing the container on a computer screen, it is possible to faithfully reproduce the container figure with a smoothed outer shape of representation.

Also, since a three-dimensional outer shape of the container is defined as a solid model filled up with contents, it is possible to perform a high-speed calculation of a container capacity, a center of gravity, a tipping angle or the like without treating the interior of the container.

Moreover, since the shape condition is inputted upon being parametrically defined, it is possible to quantitatively determine the shape of the container, and when inputting a rough outer shape, the inputting operation is easier than that in a wire frame model.

In the present invention of claim 2, the container designing system may subject the solid model to a secondary processing after defining the outer shape of the hollow container as a solid model.

According to the structure of claim 2, by subjecting the solid model to a secondary processing after defining the outer shape of the container as a solid model, an opening portion closing treatment required in a surface model is not required after a Boolean operation, thus performing an effective and high-speed secondary processing of the outer shape.

In the present invention of claim 3, the solid model editing means may subject the solid model to a secondary processing by using a Boolean operation for altering a shape upon calculating a logical sum (OR), a logical difference (XOR) or a logical product (AND) of two shapes.

According to the structure of claim 3, since it is possible to subject the solid model to a secondary processing by using a Boolean operation, it is possible to perform a shape alteration such that a specified shape is taken out or adhered to an outer shape of a general container, thus designing a varied outer shape.

In the present invention of claim 4, the solid model editing means may subject the solid model to a secondary processing by using a fillet operation for smoothly rounding an intersecting portion of one plane with the other plane.

According to the structure of claim 4, since it is possible to subject the solid model to a secondary processing by using a fillet operation, it is possible to easily design the outer shape that is easily produced, by smoothly rounding an intersecting portion of one plane with the other plane.

In the present invention of claim 5, the solid model editing means may subject the solid model to a secondary processing by using a deformable operation for altering a plane such that a positive load or a negative load is applied to the plane.

According to the structure of claim 5, since it is possible to subject the solid model to a secondary processing by using a deformable operation, it is possible to perform an alteration such that a positive load or a negative load is applied to a plane with the feeling that an operator presses or sucks a piece of clay with his finger, thus easily designing a varied outer shape.

In the present invention of claim 6, the solid model editing means may subject the solid model to a secondary processing by using a spiral operation for generating a continuous rugged shape on an exterior surface of the hollow container in an arbitrary range of an axial direction.

According to the structure of claim 6, since it is possible to subject the solid model to a secondary processing by using a spiral operation, a continuous rugged shape is generated on an exterior surface of the hollow container in an arbitrary range of an axial direction, thus easily designing a varied outer shape.

In the present invention of claim 7, the container designing system may comprise a capacity modulating means for performing a shape modulation upon the outer shape in order that a container capacity after a shape modulation has a capacity determined by the shape condition.

According to the structure of claim 7, since a capacity modulating means is provided for performing a shape modulation upon the outer shape in order that a container capacity after a shape modulation has a capacity determined by the shape condition, it is possible to efficiently design the outer shape without being conscious of the container capacity at a secondary processing.

In the present invention of claim 8, the container designing system may subject the outer shape to a secondary processing under the condition that a shape of a finish portion of the hollow container is fixed.

According to the structure of claim 8, since it is possible to subject the outer shape to a secondary processing under the condition that the shape of the finish portion is fixed, there is no case where the shape of the finish portion is automatically altered by the secondary processing. Owing to this, it is possible to subject the outer shape to a secondary processing without paying attention to the predetermined shape of the finish portion, thus improving the operationability of the secondary processing.

In the present invention of claim 9, the container designing system may perform the shape modulation upon the outer shape under the condition that a shape of a finish portion of the hollow container is fixed.

According to the structure of claim 9, the shape of the finish portion is not altered when the outer shape is modulated by the capacity modulating means in order that a container capacity after a shape modulation has a capacity determined by the shape condition, therefore, it is not needed to reconfirm the shape of the finish portion, thus efficiently designing the container.

In the present invention of claim 10, a parametrically-defined shape condition is inputted and a three-dimensional outer shape of the hollow container is defined as a solid model filled up with contents on the basis of the shape condition, after that, the solid model is subjected to a secondary processing.

According to the structure of claim 10, since the outer shape of the container is defined as a solid model, when previewing the container on a computer screen, it is possible to faithfully reproduce the container figure with a smoothed outer shape of representation.

Also, since a three-dimensional outer shape of the container is defined as a solid model filled up with contents, it is possible to perform a high-speed calculation of a container capacity, a center of gravity, a tipping angle or the like without treating the interior of the container.

Moreover, since the shape condition is inputted upon being parametrically defined, it is possible to quantitatively determine the shape of the container, and when inputting a rough outer shape, the inputting operation is easier than that in a wire frame model.

In the present invention of claim 11, the container designing method may subject the solid model to a secondary processing by using a Boolean operation for altering a shape upon calculating a logical sum (OR), a logical difference (XOR) or a logical product (AND) of two shapes.

According to the structure of claim 11, since it is possible to subject the solid model to a secondary processing by using a Boolean operation, it is possible to perform a shape alteration such that a specified shape is taken out or adhered to an outer shape of a general container, thus designing a varied outer shape.

In the present invention of claim 12, the container designing method may subject the solid model to a secondary processing by using a fillet operation for smoothly rounding an intersecting portion of one plane with the other plane.

According to the structure of claim 12, since it is possible to subject the solid model to a secondary processing by using a fillet operation, it is possible to easily design the outer shape that is easily produced, by smoothly rounding an intersecting portion of one plane with the other plane.

In the present invention of claim 13, the container designing method may subject the solid model to a secondary processing by using a deformable operation for altering a plane such that a positive load or a negative load is applied to the plane.

According to the structure of claim 13, since it is possible to subject the solid model to a secondary processing by using a deformable operation, it is possible to perform an alteration such that a positive load or a negative load is applied to a plane with the feeling that an operator presses or sucks a piece of clay with his finger, thus easily designing a varied outer shape.

In the present invention of claim 14, the container designing method may subject the solid model to a secondary processing by using a spiral operation for generating a continuous rugged shape on an exterior surface of the hollow container in an arbitrary range of an axial direction.

According to the structure of claim 14, since it is possible to subject the solid model to a secondary processing by using a spiral operation, a continuous rugged shape is generated on an exterior surface of the hollow container in an arbitrary range of an axial direction, thus easily designing a varied outer shape.

In the present invention of claim 15, the container designing method may perform a shape modulation upon the outer shape in order that a container capacity after a shape modulation has a capacity determined by the shape condition.

According to the structure of claim 15, since a shape modulation upon the outer shape is performed in order that a container capacity after a shape modulation has a capacity determined by the shape condition, it is possible to efficiently design the outer shape without being conscious of the container capacity at a secondary processing.

In the present invention of claim 16, the container designing method may subject the outer shape to a secondary processing under the condition that a shape of a finish portion of the hollow container is fixed.

According to the structure of claim 16, since it is possible to subject the outer shape to a secondary processing under the condition that the shape of the finish portion is fixed, there is no case where the shape of the finish portion is automatically altered by the secondary processing. Owing to this, it is possible to subject the outer shape to a secondary processing without paying attention to the predetermined shape of the finish portion, thus improving the operationability of the secondary processing.

In the present invention of claim 17, the container designing method may perform the shape modulation upon the outer shape under the condition that a shape of a finish portion of the hollow container is fixed.

According to the structure of claim 17, the shape of the finish portion is not altered when the outer shape is modulated by the capacity modulating means in order that a container capacity after a shape modulation has a capacity determined by the shape condition, therefore, it is not needed to reconfirm the shape of the finish portion, thus efficiently designing the container.

In the present invention of claim 18, the container designing program may be used for carrying out by a computer a parametric inputting means for inputting a parametrically defined shape condition, a storing means for storing a shape condition, a solid model defining means for defining a three-dimensional outer shape of a hollow container as a solid model filled up with contents on the basis of the shape condition, and a solid model editing means for subjecting the solid model to a secondary processing.

According to the structure of claim 18, since the outer shape of the container is defined as a solid model, when previewing the container on a computer screen, it is possible to faithfully reproduce the container figure with a smoothed outer shape of representation.

Also, since a three-dimensional outer shape of the container is defined as a solid model filled up with contents, it is possible to perform a high-speed calculation of a container capacity, a center of gravity, a tipping angle or the like without treating the interior of the container.

Moreover, since the shape condition is inputted upon being parametrically defined, it is possible to quantitatively determine the shape of the container, and when inputting a rough outer shape, the inputting operation is easier than that in a wire frame model.

In the present invention of claim 19, the container designing program may subject the solid model to a secondary processing after defining the outer shape of the hollow container as a solid model.

According to the structure of claim 19, by subjecting the solid model to a secondary processing after defining the outer shape of the container as a solid model, an opening portion closing treatment required in a surface model is not required after a Boolean operation, thus performing an effective and high-speed secondary processing of the outer shape.

In the present invention of claim 20, the solid model editing means may subject the solid model to a secondary processing by using a Boolean operation for altering a shape upon calculating a logical sum (OR), a logical difference (XOR) or a logical product (AND) of two shapes.

According to the structure of claim 20, since it is possible to subject the solid model to a secondary processing by using a Boolean operation, it is possible to perform a shape alteration such that a specified shape is taken out or adhered to an outer shape of a general container, thus designing a varied outer shape.

In the present invention of claim 21, the solid model editing means may subject the solid model to a secondary processing by using a fillet operation for smoothly rounding an intersecting portion of one plane with the other plane.

According to the structure of claim 21, since it is possible to subject the solid model to a secondary processing by using a fillet operation, it is possible to easily design the outer shape that is easily produced, by smoothly rounding an intersecting portion of one plane with the other plane.

In the present invention of claim 22, the solid model editing means may subject the solid model to a secondary processing by using a deformable operation for altering a plane such that a positive load or a negative load is applied to the plane.

According to the structure of claim 22, since it is possible to subject the solid model to a secondary processing by using a deformable operation, it is possible to perform an alteration such that a positive load or a negative load is applied to a plane with the feeling that an operator presses or sucks a piece of clay with his finger, thus easily designing a varied outer shape.

In the present invention of claim 23, the solid model editing means may subject the solid model to a secondary processing by using a spiral operation for generating a continuous rugged shape on an exterior surface of the hollow container in an arbitrary range of an axial direction.

According to the structure of claim 23, since it is possible to subject the solid model to a secondary processing by using a spiral operation, a continuous rugged shape is generated on an exterior surface of the hollow container in an arbitrary range of an axial direction, thus easily designing a varied outer shape.

In the present invention of claim 24, the container designing program may comprise a capacity modulating means for performing a shape modulation upon the outer shape in order that a container capacity after a shape modulation has a capacity determined by the shape condition.

According to the structure of claim 24, since a capacity modulating means is provided for performing a shape modulation upon the outer shape in order that a container capacity after a shape modulation has a capacity determined by the shape condition, it is possible to efficiently design the outer shape without being conscious of the container capacity at a secondary processing.

In the present invention of claim 25, the container designing program may subject the outer shape to a secondary processing under the condition that a shape of a finish portion of the hollow container is fixed.

According to the structure of claim 25, since it is possible to subject the outer shape to a secondary processing under the condition that the shape of the finish portion is fixed, there is no case where the shape of the finish portion is automatically altered by the secondary processing. Owing to this, it is possible to subject the outer shape to a secondary processing without paying attention to the predetermined shape of the finish portion, thus improving the operationability of the secondary processing.

In the present invention of claim 26, the container designing program may perform the shape modulation upon the outer shape under the condition that a shape of a finish portion of the hollow container is fixed.

According to the structure of claim 26, the shape of the finish portion is not altered when the outer shape is modulated by the capacity modulating means in order that a container capacity after a shape modulation has a capacity determined by the shape condition, therefore, it is not needed to reconfirm the shape of the finish portion, thus efficiently designing the container.

In the present invention of claim 27, the computer-accessible recording medium has recorded a container designing program for carrying out by a computer a parametric inputting means for inputting a parametrically-defined shape condition, a storing means for storing a shape condition, a solid model defining means for defining a three-dimensional outer shape of a hollow container as a solid model filled up with contents on the basis of the shape condition, and a solid model editing means for subjecting the solid model to a secondary processing.

According to the structure of claim 27, since the outer shape of the container is defined as a solid model, when previewing the container on a computer screen, it is possible to faithfully reproduce the container figure with a smoothed outer shape of representation.

Also, since a three-dimensional outer shape of the container is defined as a solid model filled up with contents, it is possible to perform a high-speed calculation of a container capacity, a center of gravity, a tipping angle or the like without treating the interior of the container.

Moreover, since the shape condition is inputted upon being parametrically defined, it is possible to quantitatively determine the shape of the container, and when inputting a rough outer shape, the inputting operation is easier than that in a wire frame model.

In the present invention of claim 28, the computer-accessible recording medium has recorded a container designing program for subjecting the solid model to a secondary processing after the outer shape of the hollow container is defined as a solid model.

According to the structure of claim 28, by subjecting the solid model to a secondary processing after defining the outer shape of the container as a solid model, an opening portion closing treatment required in a surface model is not required after a Boolean operation, thus performing an effective and high-speed secondary processing of the outer shape.

In the present invention of claim 29, the computer-accessible recording medium has recorded a container designing program where the solid model editing means subjects the solid model to a secondary processing by using a Boolean operation for altering a shape upon calculating a logical sum (OR), a logical difference (XOR) or a logical product (AND) of two shapes.

According to the structure of claim 29, since it is possible to subject the solid model to a secondary processing by using a Boolean operation, it is possible to perform a shape alteration such that a specified shape is taken out or adhered to an outer shape of a general container, thus designing a varied outer shape.

In the present invention of claim 30, the computer-accessible recording medium has recorded a container designing program where the solid model editing means subjects the solid model to a secondary processing by using a fillet operation for smoothly rounding an intersecting portion of one plane with the other plane.

According to the structure of claim 30, since it is possible to subject the solid model to a secondary processing by using a fillet operation, it is possible to easily design the outer shape that is easily produced, by smoothly rounding an intersecting portion of one plane with the other plane.

In the present invention of claim 31, the computer-accessible recording medium has recorded a container designing pro gram where the solid model editing means subjects the solid model to a secondary processing by using a deformable operation for altering a plane such that a positive load or a negative load is applied to the plane.

According to the structure of claim 31, since it is possible to subject the solid model to a secondary processing by using a deformable operation, it is possible to perform an alteration such that a positive load or a negative load is applied to a plane with the feeling that an operator presses or sucks a piece of clay with his finger, thus easily designing a varied outer shape.

In the present invention of claim 32, the computer-accessible recording medium has recorded a container designing program where the solid model editing means subjects the solid model to a secondary processing by using a spiral operation for generating a continuous rugged shape on an exterior surface of the hollow container in an arbitrary range of an axial direction.

According to the structure of claim 32, since it is possible to subject the solid model to a secondary processing by using a spiral operation, a continuous rugged shape is generated on an exterior surface of the hollow container in an arbitrary range of an axial direction, thus easily designing a varied outer shape.

In the present invention of claim 33, the computer-accessible recording medium has recorded a container designing program carrying out by a computer a capacity modulating means for performing a shape modulation upon the outer shape in order that a container capacity after a shape modulation has a capacity determined by the shape condition.

According to the structure of claim 33, since a capacity modulating means is provided for performing a shape modulation upon the outer shape in order that a container capacity after a shape modulation has a capacity determined by the shape condition, it is possible to efficiently design the outer shape without being conscious of the container capacity at a secondary processing.

In the present invention of claim 34, the computer-accessible recording medium has recorded a container designing program where it is possible to subject the outer shape to a secondary processing under the condition that a shape of a finish portion of the hollow container is fixed.

According to the structure of claim 34, since it is possible to subject the outer shape to a secondary processing under the condition that the shape of the finish portion is fixed, there is no case where the shape of the finish portion is automatically altered by the secondary processing. Owing to this, it is possible to subject the outer shape to a secondary processing without paying attention to the predetermined shape of the finish portion, thus improving the operationability of the secondary processing.

In the present invention of claim 35, the computer-accessible recording medium has recorded a container designing program where it is possible to perform the shape modulation upon the outer shape under the condition that a shape of a finish portion of the hollow container is fixed.

According to the structure of claim 35, the shape of the finish portion is not altered when the outer shape is modulated by the capacity modulating means in order that a container capacity after a shape modulation has a capacity determined by the shape condition, therefore, it is not needed to reconfirm the shape of the finish portion, thus efficiently designing the container.

### BRIEF DESCRIPTION OF DRAWINGS

FIG. 1 is a structural view illustrating an example of a container designing system according to the present invention.

FIG. 2 is a flowchart schematically illustrating the operation of the same.

FIG. 3 is a flowchart illustrating a more detailed operation.

FIG. 4 is a window explanatory view illustrating a parametric input window of the same.

FIG. 5 is an explanatory view for explaining an input of a cross-sectional profile of the same.

FIG. 6 is a solid model drawing illustrating a defined bottle in the same.

FIG. 7 is a wire frame drawing illustrating a defined bottle in the same.

FIG. 8 is a flowchart in the case where a secondary processing is performed by a Boolean operation in the same.

FIG. 9 is a wire frame drawing illustrating a tool of a Boolean operation in the same.

FIG. 10 is a wire frame drawing for explaining a Boolean operation in the same.

FIG. 11 is a solid model drawing for explaining a Boolean operation in the same.

FIG. 12 is a solid model drawing after a Boolean operation is performed in the same.

FIG. 13 is a wire frame drawing after a Boolean operation is performed in the same.

FIG. 14 is a wire frame drawing illustrating a component of a Boolean operation in the same.

FIG. 15 is a wire frame drawing after a Boolean operation is performed with a component in the same.

FIG. 16 is a solid model drawing after a Boolean operation is performed with a component in the same.

FIG. 17 is a flowchart in the case where a secondary processing is performed by a deformable operation in the same.

FIG. 18 is a wire frame drawing illustrating an area-designated state at a deformable operation in the same.

FIG. 19 is a wire frame drawing illustrating a positive-load applied state by a deformable operation in the same.

FIG. 20 is a solid model drawing illustrating a positive-load applied state by a deformable operation in the same.

FIG. 21 is a wire frame drawing illustrating a negative-load applied state by a deformable operation in the same.

FIG. 22 is a solid model drawing illustrating a negative-load applied state by a deformable operation in the same.

FIG. 23 is a flowchart in the case where a secondary processing is performed by a spiral operation in the same.

FIG. 24 is a wire frame drawing illustrating an area-designated state at a spiral operation in the same.

FIG. 25 is a solid model drawing illustrating a secondary processing performed state by a spiral operation in the same.

### DESCRIPTION OF THE PREFERRED EMBODIMENT

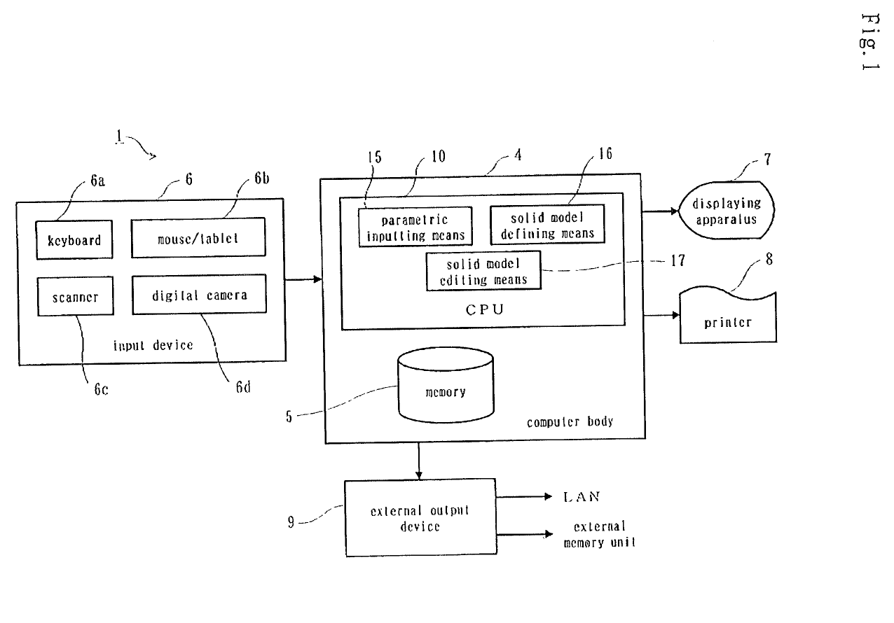

In FIG. 1 to FIG. 25, a container designing system 1 is used for designing an outer shape of a hollow container such as a glass bottle, a can, a synthetic resin container, for example, a polyethyleneterephthalate (PET) resin bottle, or the like. The container designing system 1 is implemented by a computer (for example, a personal computer as a small sized general purpose computer) as an electronic calculator for realizing an information system. As shown in FIG. 1, a computer body 4 is composed of a central processing unit (CPU) 10 for controlling the internal portions thereof or the like, and a memory 5 for storing data of all kinds. In the inside of the CPU 10, a parametric inputting means 15, a solid model defining means 16, a solid model editing means 17 and the like are implemented as software, respectively. In addition, these means are constructed as functions in order to operate on a three-dimensional (3D)-computer aided design (CAD) software.

Moreover, the computer body 4 is connected with various kinds of input devices 6 for inputting information. The input devices 6 include a keyboard 6a for directly inputting numerical values or the like, a mouse or a tablet 6b as a pointing device, a scanner 6c for inputting written images, a digital camera 6d for inputting three-dimensional pictures as photo images, and the like. Its form is not particularly limited provided that it can transmit information to the computer body 4. Note that, an LAN or an external memory unit connected to an external output device 9, which is explained later, will reasonably correspond to the input device 6 stated here when applied as an input device.

Furthermore, the computer body 4 is connected with an external device such as a displaying apparatus 7 (for example, a CRT, a liquid crystal display or the like) for displaying information of all kinds, a printer 8 for printing information of all kinds, an external output device 9 or the like. The external output device 9 is used for transmitting a bottle shape data (S105) of a container designed by each of technique, which are explained later, to the devices except the container designing system 1, or outputting the data to an external storing means. The external output device 9 can be connected through a telecommunication line to a network such as a local area network (LAN), a wide area network (WAN) or Ethernet. Also, the external output device 9 can be connected to an external memory unit such as a hard disk (HD), a flexible disk, a CD-ROM or a magnet optical disk (MO). Note that, the external output device 9 can be of any type that can output a bottle shape data (S105) of an outer shape to the outside of the computer body 4.

Incidentally, the computer body 4 is not limited to a desktop computer and can be a laptop personal computer or a notebook-sized personal computer where the keyboard 6a and the displaying apparatus 7 are united with the computer body 4.

As a storage medium used for the memory 5, a hard disk (HD), a random access memory (RAM) or whatever the CPU 10 can read from and write data into can be used. The data to be stored in the memory 5 is, to be concrete, a bottle shape data (S105) of a container outer shape. Note that, the memory 5 is not limited to an internal memory, which is of the type directly connected to the CPU 10, and can be an external memory unit to be used as an external memory of the computer. The external memory unit itself is as stated above.

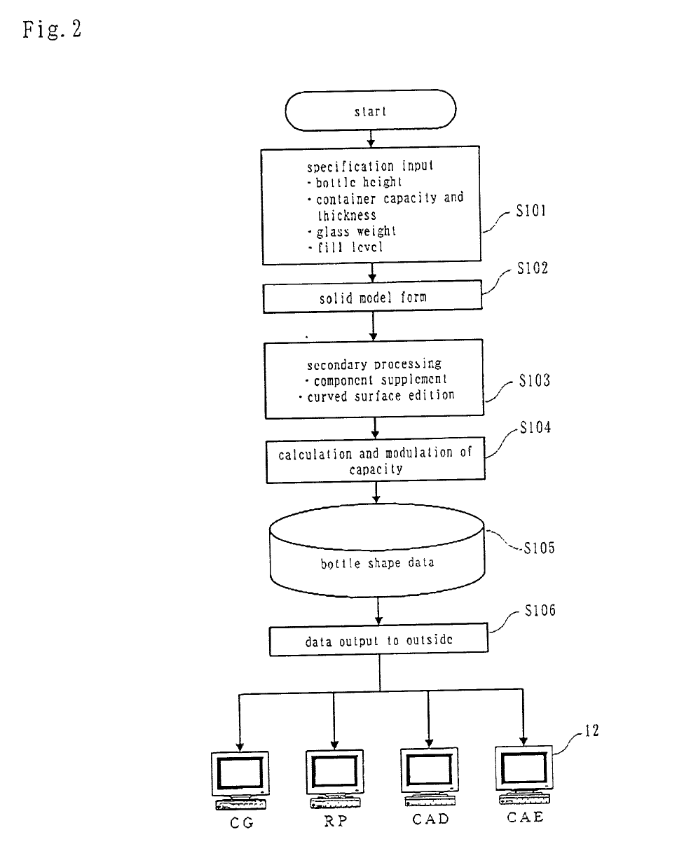

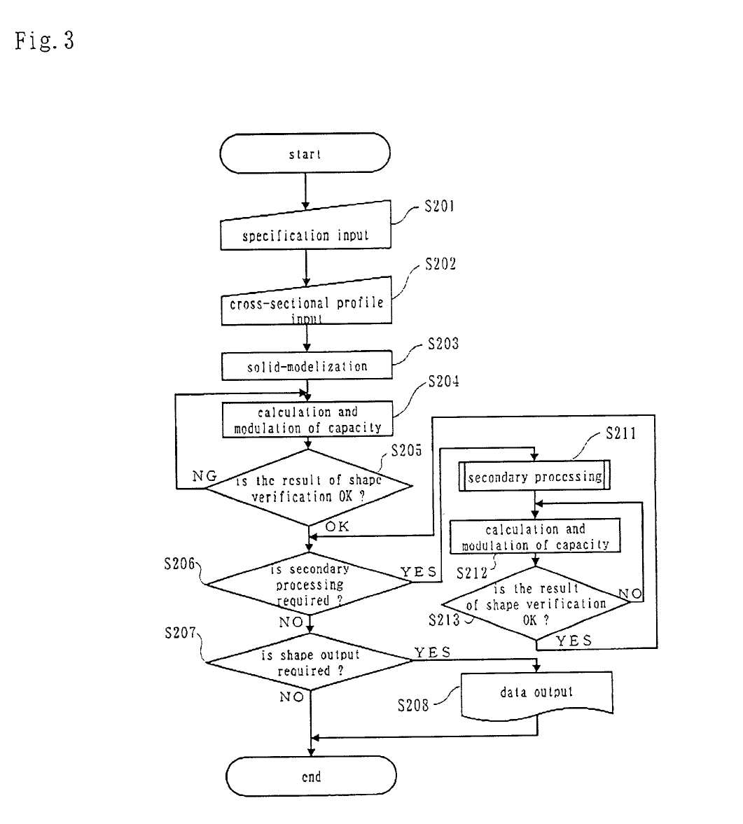

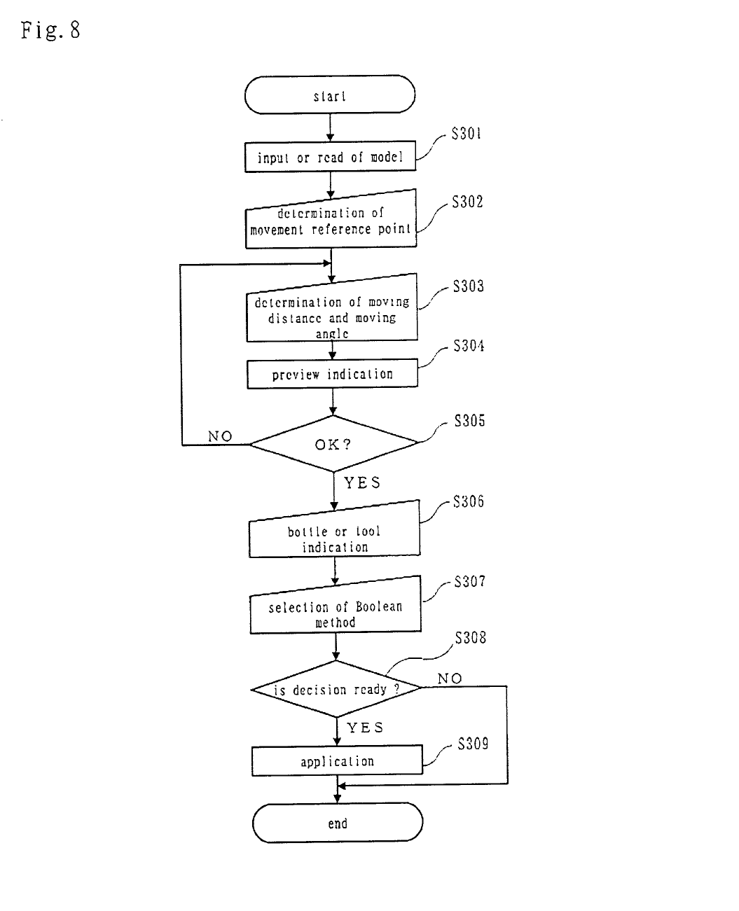

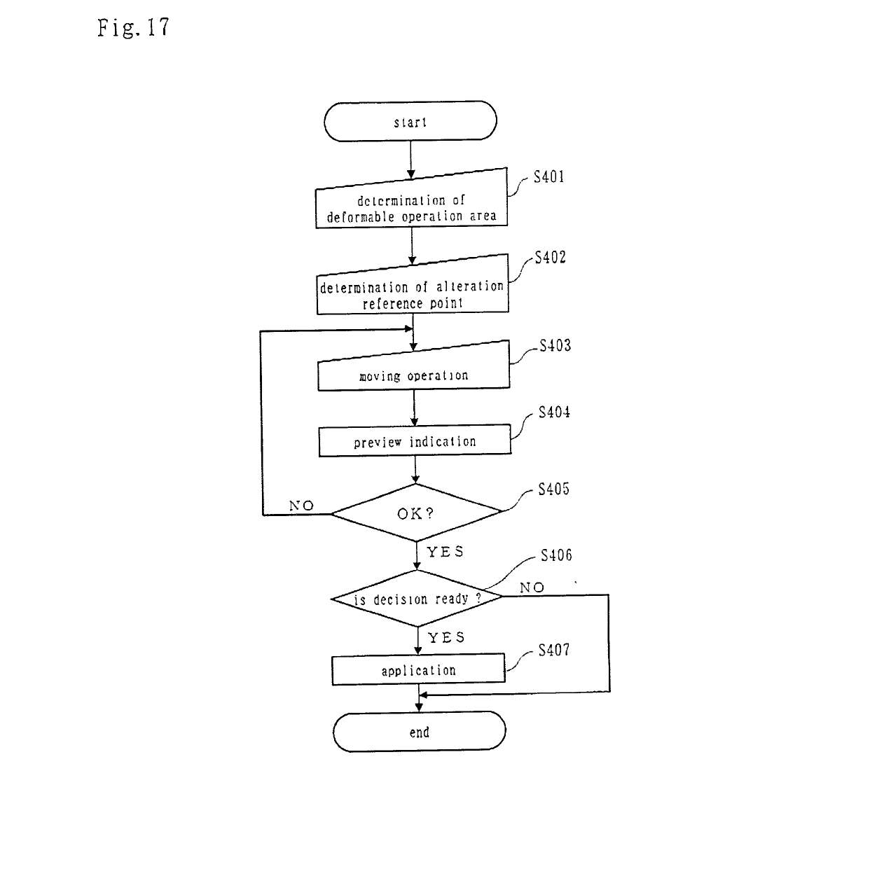

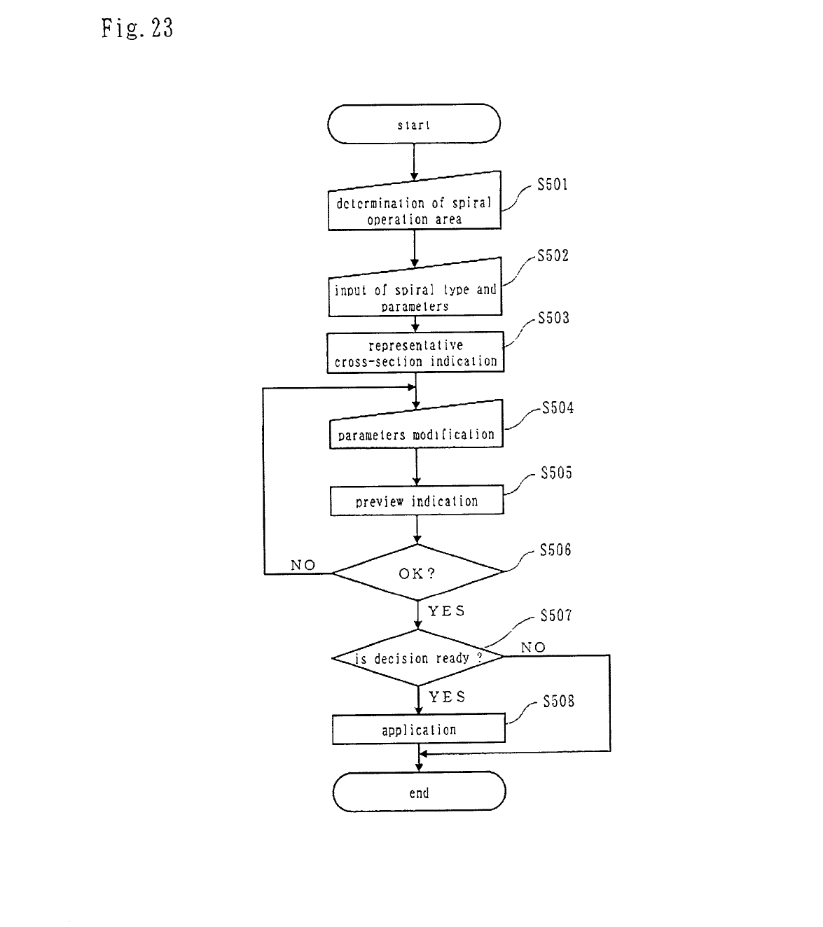

Next, the operation of the container designing system 1 according to the present invention will be explained. Thereupon, in the explanation of the following carrying-out mode, reference numerals in parentheses correspond to those of flowcharts in FIG. 2, FIG. 3, FIG. 8, FIG. 17 and FIG. 23.

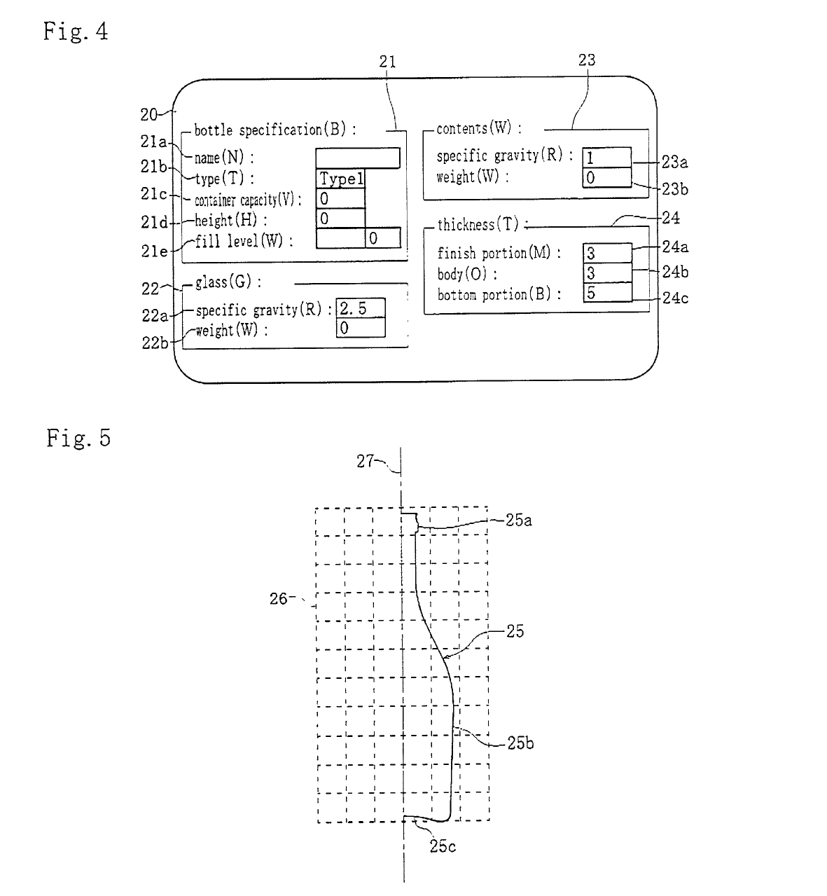

First of all, parametrically defined (as numerical values) shape conditions showing a rough outer shape of a container are inputted by the parametric inputting means 15 (S101, S201). A window example to realize the parametric inputting means 15 is shown in FIG. 4. Note that, the container to be designed in the present embodiment is a glass bottle. However, the container is not limited to a glass bottle, and it can be of any type of hollow container, no matter how it is shaped and no matter what it is made of. As shown in FIG. 4, in a parametric inputting window 20, a bottle specification 21, a glass specification 22, a contents specification 23, a bottle thickness specification 24 and the like are inputted, respectively. As concrete inputting values or the like, in the bottle specification 21, a bottle name 21a, a type 21b showing whether the bottle is a round bottle, a non-round bottle or the like, the container capacity 21c, the height 21d and a fill level 21e, which is a distance between a liquid level of the contents and a top of the bottle, are inputted. And also a fill level 21e can be a headspace capacity or a ratio of a headspace capacity to a container capacity. In the glass specification 22, the specific gravity of the glass 22a and the weight 22b are inputted. In the contents specification 23, the specific gravity of the contents 23a to be packed in the bottle, and the weight 23b are inputted. In the thickness specification 24, each thickness of the bottle portions is inputted. The portions are a finish portion 24a, a body 24b, a bottom portion 24c and the like. Note that, with respect to the values usable in common with other bottles, it would be convenient to store and keep them in the memory 5.

Subsequently, a bottle shape is inputted. The bottle shape input is performed by inputting a cross-sectional profile (S202). For a round bottle, since the structure has a rotation axis 27, a practical input can be performed by determining one-side cross-sectional profile pertaining to the rotation axis 27. First, a profile of a finish portion 25a is inputted on a CAD. In a conventional use, since a predetermined profile of the finish portion is taken thereon, a profile of the finish portion is designed in advance to store into the memory 5, and then the profile will be read out to apply thereon. Next, the body 25b is inputted. In the case of inputting the body 25b, straight lines are first inputted and combined each other to form a rough profile, and then intersecting points of those straight lines are rounded or the like, thus forming a bottle-like profile. As a bottom 25c, a ground width and a push-up height are inputted as parameters to form the bottom profile.

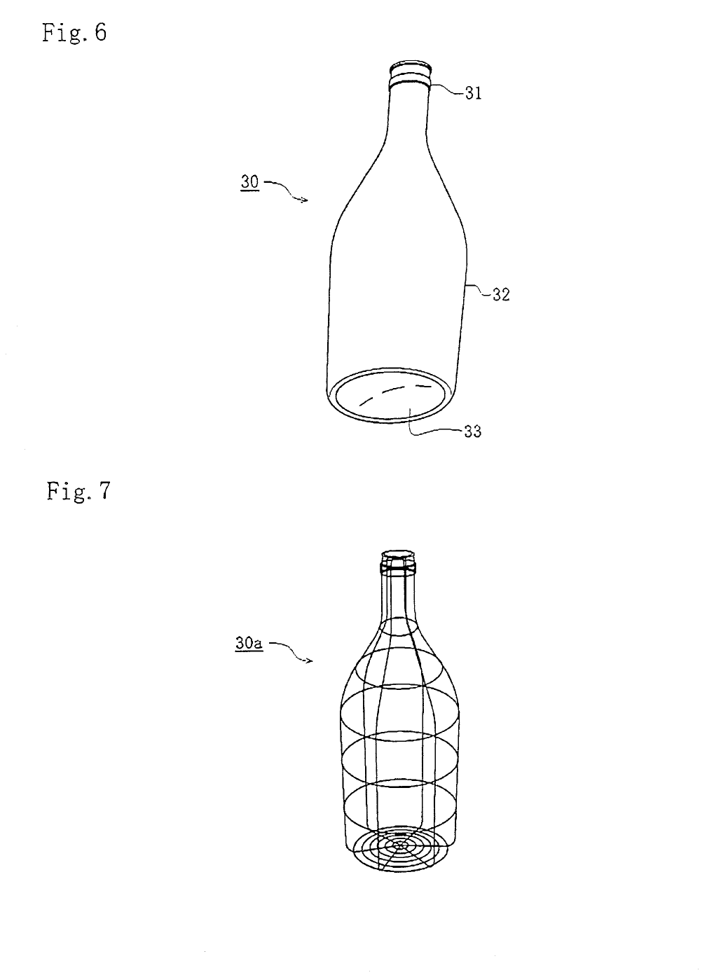

After defining a cross-sectional profile of the bottle as shown in FIG. 5, an outer shape of the bottle is defined and displayed as a solid model by means of the cross-sectional profile and the shape conditions inputted in the parametric inputting window 20, by using the solid model defining means 16 (S102, S203). The solid model is used for a three-dimensional outer shape of the bottle, defined as a substance filled up with contents. A displayed state of a bottle 30 defined by the solid model is shown in FIG. 6. Meanwhile, a wire frame 30a of the bottle 30 generated by the solid model defining means 16, which is not showing the surface of the solid model, is shown in FIG. 7. The representation using a wire frame model in the present embodiment, however, is used only to explain the present embodiment so the actual solid model is a real substance filled up with contents.

After a solid-modelization is finished, the model will be subjected to a secondary processing, as the need arises, such as a modification and alteration for altering the outer shape or supplementing some components (S103, S206). The secondary processing is actually an arbitrary operation, so it is judged by an operator whether the secondary processing is to be performed or not. That is, a shape verification (S205) is performed for the shape of the bottle 30 of the defined solid model, and then, it is verified whether the secondary processing is to be performed or not (S206) when the bottle shape meets demands (OK of S205). When the secondary processing is not needed (NO of S206), it is determined whether a bottle shape data (S105) stated later is to be outputted to the outside of the computer or not (S207).

When the secondary processing is selected (YES of S206), the secondary processing is performed (S211) and then calculation and modulation of capacity is performed (S212). In this situation, a shape verification is performed (S213), and when the bottle shape does not meet demands (NO of S213), calculation and modulation of capacity (S212) is performed again. When it is good, it is judged whether the secondary processing is to be performed further or not (S206), when the secondary processing is not selected (NO of S206), it is determined whether a bottle shape data (S105) stated later is to be outputted to the outside of the computer or not (S207).

In the calculation and modulation of capacity (capacity modulating means), various kinds of values are first calculated by means of the designed outer shape and the shape conditions inputted by the parametric inputting means 15. Those values are a container capacity, a center of gravity, a tipping angle and the like. All of those data will be outputted to the outside of the computer with the bottle shape data (S105) of the outer shape to be utilized as information for manufacturing the bottle 30.

Meanwhile, a subtle modulation for a parametric model is needed in order that the parametric model agrees with the capacity or the like inputted by the parametric inputting means 15. For the bottle 30, since it is restricted so as to use a predetermined shape of cap, the alteration of the body 32 and a bottom 33 will be performed without changing the shape of the finish portion 31. As an actual altering technique, a body width alteration, a full-length alteration, a similitude alteration and the like will be performed under the condition that the shape of the finish portion 31 is fixed. The body width alteration means to alter the width of the body 32 without changing the height of the bottle 30. The full-length alteration means to alter the height of the bottle 30 without changing the width of the body 32. The similitude alteration means to alter both the height and the width of the bottle 30 under the condition that the ratio of the height to the width of the bottle 30 is kept.

A capacity modulating means is provided for performing a shape modulation upon the outer shape in order that a container capacity after a shape modulation has a capacity determined by the shape condition, so that it is possible to efficiently design the outer shape without being conscious of the container capacity at a secondary processing.

Also, since the shape of the finish portion is not altered when the outer shape is modulated by the capacity modulating means in order that a container capacity after a shape modulation has a capacity determined by the shape condition, it is not needed to reconfirm the shape of the finish portion, thus efficiently designing a container.

After the outer shape is settled, it is determined whether the bottle shape data (S105) of the completed shape is to be outputted to the outside or not (S207). If it is not needed to output the data, the operation of the container designing system 1 is closed as it is. When it is needed to output the data to the outside, the bottle shape data (S105) will be outputted (S106, S208). A means for outputting the bottle shape data (S105) is that of the above mentioned various kinds of means connected to the external output device 9. Note that, a destination of the bottle shape data (S105) is other computers 12 or manufacturing facilities of the bottle 30. In the other computers 12, the bottle shape data is utilized as the data for a computer graphics (CG), a rapid prototyping system (RP), a CAD, a computer aided engineering (CAE) or the like. That is, a type of the bottle shape data (S105) to be outputted is a drawing interchange file (DXF), a stereo lithography (STL), Japan Automobile Manufacturers Association-IGES Subset (JAMA-IS) or the like. However, the type is not limited to each of them.

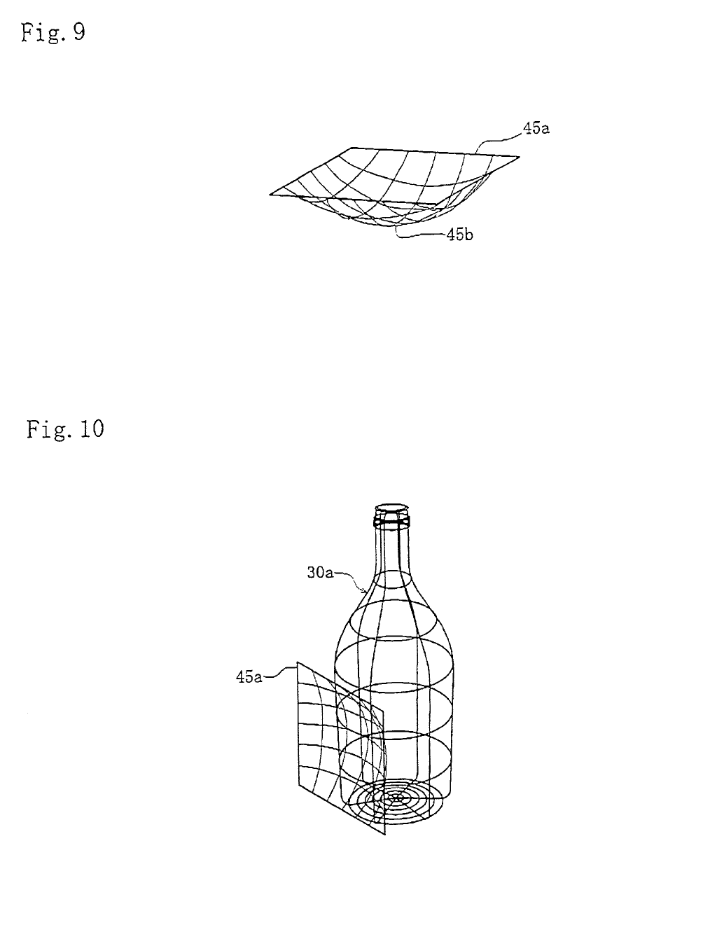

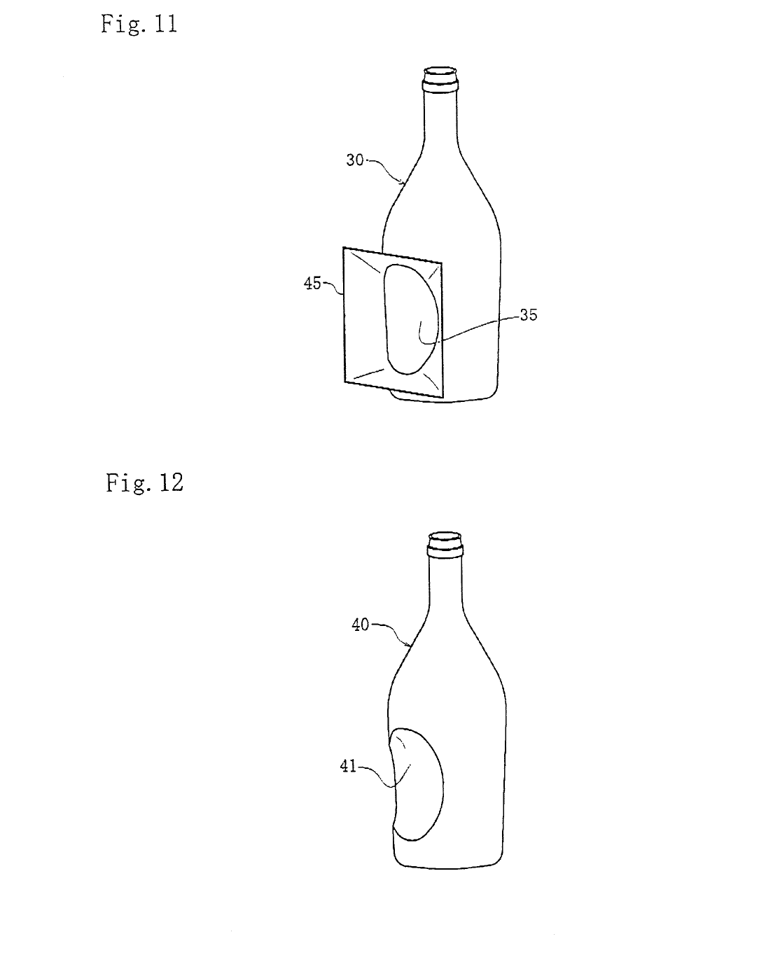

Next, a method of a secondary processing will be explained. Thereupon, it is assumed that the secondary processing is performed under the condition that the shape of the finish portion 31 is fixed. First, a method for editing a solid model by using a Boolean operation will be explained, Note that, the Boolean operation is used for performing a shape alteration by calculating a logical sum (OR), a logical difference (XOR) or a logical product (AND) of two shapes. In this situation, One of the two shapes is the bottle 30 formed in the above-stated process and the other is a spoon shaped tool 45a shown in FIG. 9. This tool 45 is inputted first and defined (S301). Otherwise, it is possible to read out and use the tool 45 upon keeping (he tool 45 in the memory 5 in advance. Note that, when defining it, the tool 45 as a solid model is inputted under a conventional CAD operation. The tool 45 indicated herein is, for example, such a spoon shaped one by pressing down a center of a sheet of paper from the above with a finger. Next, a movement reference point for moving the tool 45 toward the bottle 30 is determined (S302). The tool 45 is moved by using this movement reference point, and is cut into the bottle 30 (30a) as shown in FIG. 10 and FIG. 11 (S303).

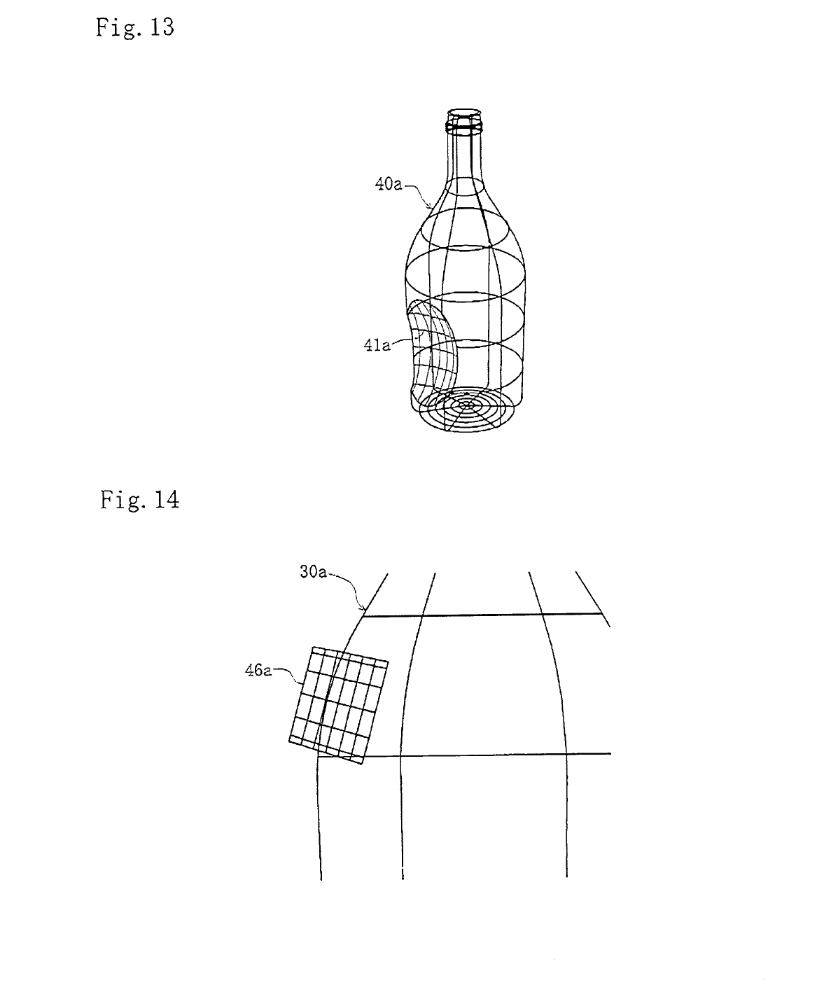

A position of the tool 45 is modified while looking at a preview indication (S304). After verifying that a position of the tool 45 is fixed (S305), when the position of the tool 45 is suitable, it is indicated whether the bottle 30 or the tool 45 is subjected to a treatment (S306). In the present embodiment, it is assumed that the bottle 30 is subjected to a treatment. Next, a selection of a Boolean method is performed (S307). A choice can be an OR operation, an XOR operation, an AND operation or the like. In the present embodiment, it is assumed that an XOR operation is selected. When those are selected and are ready for decision and application (S308), the solid model editing means 17 will perform a Boolean operation to the solid model (S309). In this example, a portion of the bottle 30 partitioned by the tool 45 is taken away by an XOR operation, and edited as a bottle 40 (40a) having a spoon-like concave portion 41 (41a) as shown in FIG. 12 and FIG. 13.

By subjecting a solid model to a secondary processing by using a Boolean operation, it is possible to perform a shape alteration such that a specified shape is gouged out from an outer shape of a general container (bottle in the present embodiment), thus designing a varied outer shape.

Note that, a rim portion of the cut concave portion 41 is left cut out in an acute angle. For a glass bottle, since it is difficult in practice to form in such a shape and also it is sharp and dangerous, it is needed to perform a treatment for smoothly rounding the intersecting portion of the body of the bottle 40 and the concave portion 41 by using a fillet operation. That is, the fillet operation is used for smoothly rounding an intersecting portion of one plane with the other plane. A designation of an edge at an intersecting portion is performed and a radius of curvature is inputted to perform a fillet operation thereby.

By subjecting a solid model to a secondary processing by using a fillet operation, it is possible to easily design the outer shape that is easily produced, by smoothly rounding an intersecting portion of one plane with the other plane.

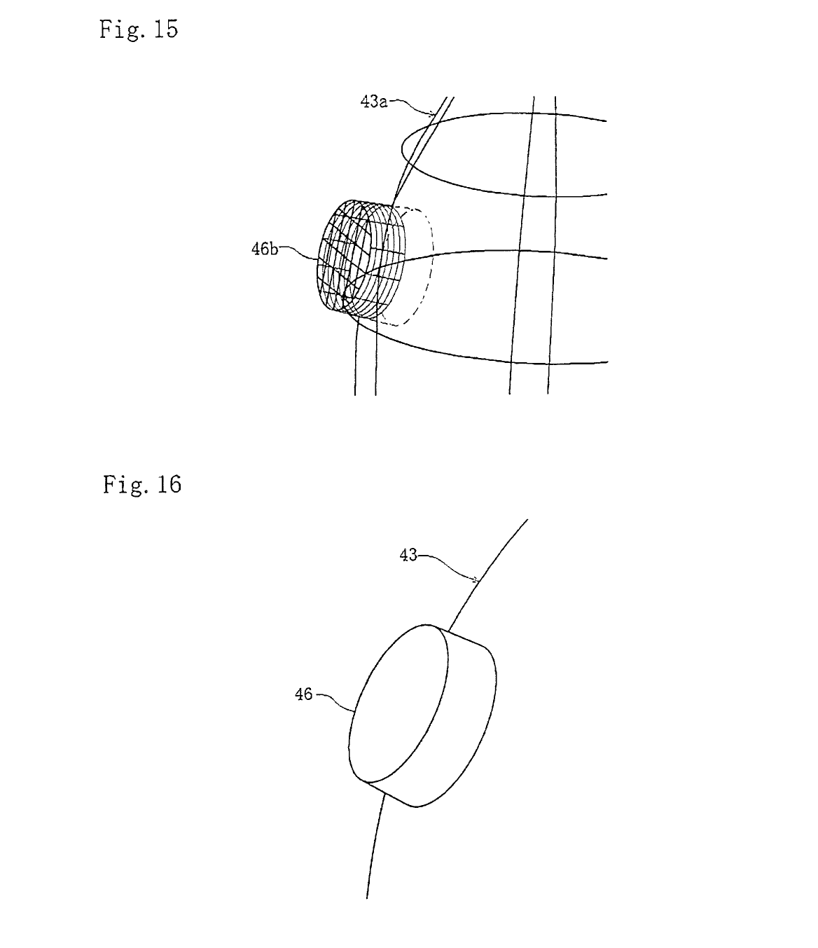

Next, the case where an OR operation is selected in a Boolean operation will be explained. A component used herein is a cylindrical component 46a. This cylindrical component 46a is buried in a predetermined position of a bottle 30aas shown in FIG. 14. And then, an OR operation of a Boolean operation is applied thereto. Then, as shown in FIG. 15 and FIG. 16, the edited bottle is formed into such a shape where the cylindrical component 46 (46b ) is adhered to a bottle 43 (43a). Note that, the component is not limited to the cylindrical component 46, and it can be a component of, for example, a polygonal prism, a sphere, a ring member or the like, which means the component not to be limited to its shape. Note that, it is possible to perform a Boolean operation of one component with another component, a Boolean operation of a tool with a component, or a Boolean operation of one tool with another tool.

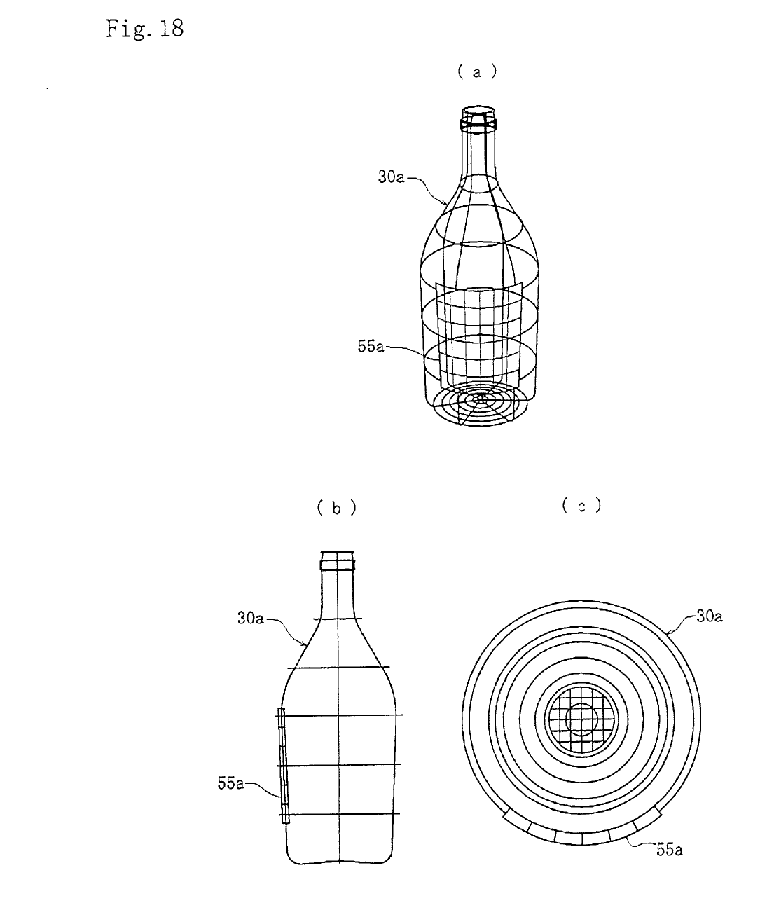

Next, a method for editing a solid model by using a deformable operation will be explained. Note that, the deformable operation is used for altering a plane such that a positive load or a negative load is applied to the plane. First, it is determined which part of the bottle 30 is subjected to a deformable operation (S401). In this example, as shown in FIG. 18, an area 55a is determined on a body portion of the bottle 30a.

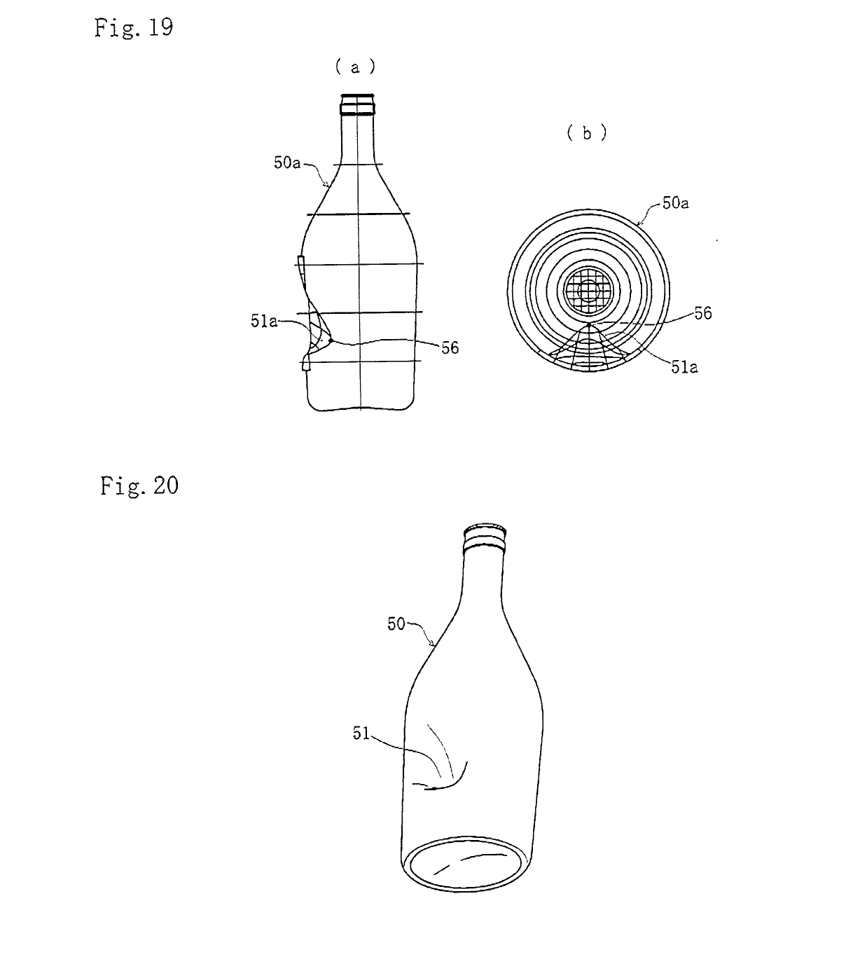

Next, a point is set to the area 55a and designated as an alteration reference point 56 (S402), and assuming this alteration reference point 56 to be a press point, a CAD is operated such that the point is pressed by a finger to be applied a load (positive load) (S403). That is, it is a feeling that a concave portion 51a is made on the area 55a by pressing the alteration reference point 56 with a finger for a soft and inelastic bottle-shaped mass, which is like a piece of clay (FIG. 20). A press degree or a press direction (the moving direction and moving amount of the alteration reference point) is modified (S405) while looking at a preview indication (S404). When the moving operation is ready for decision and application (S406), a solid model editing means 17 will perform a deformable operation to the solid model (S407). Then a bottle 50 (50a) having a concave portion 51 (51a), which is like a depression pressed by a finger, will be formed as shown in FIG. 19 and FIG. 20.

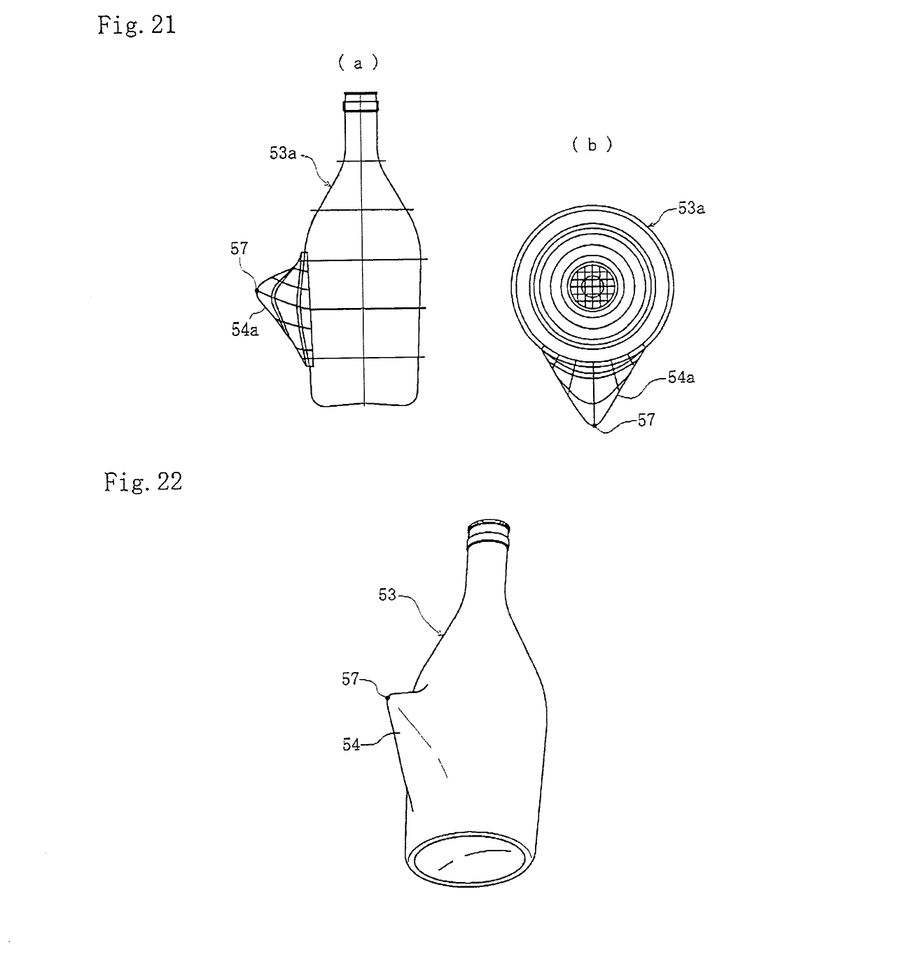

In the above-stated deformable operation, although the concave portion 51 is formed by applying a positive load, a convex portion can be formed by applying a negative load. In concrete terms, as shown in FIG. 21 and FIG. 22, an operation such as sucking the alteration reference point 57 is performed on a CAD, thus forming a convex portion 54 (54a).

By subjecting a solid model to a secondary processing by using a deformable operation, it is possible to perform an alteration such that a positive load or a negative load is applied to a plane with the feeling that an operator presses or sucks a piece of clay with his finger, thus easily designing the outer shape of varied bottles 50 and 53.

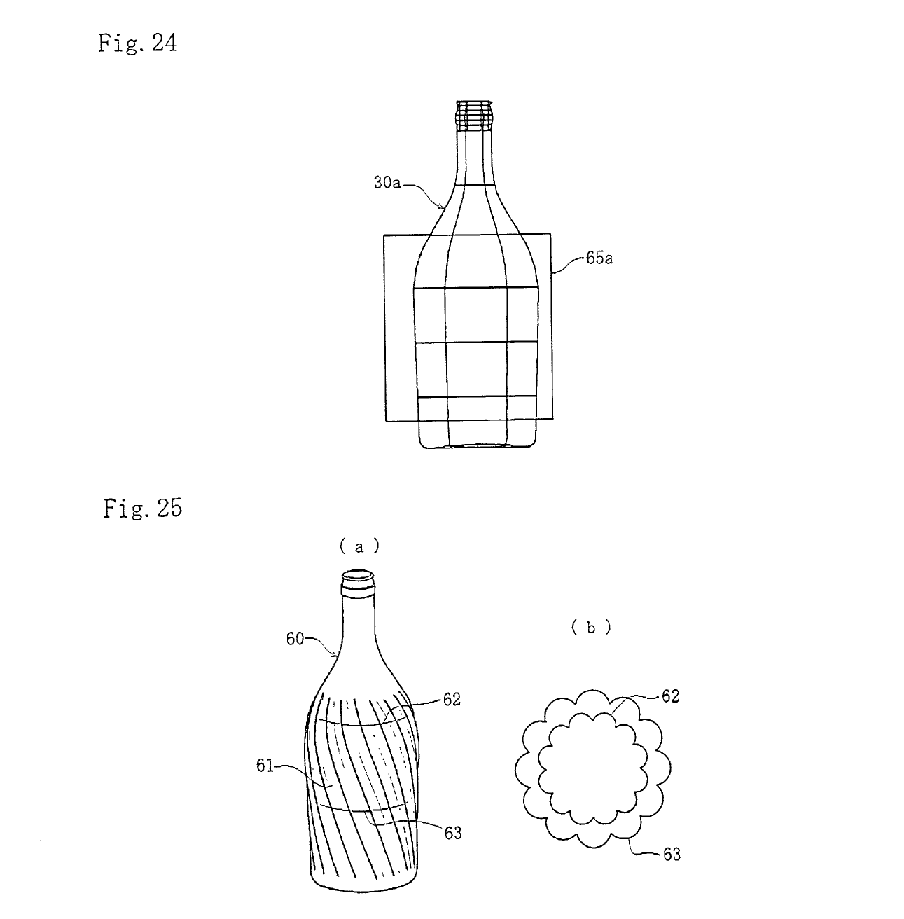

Next, a method for editing a solid model by using a spiral operation will be explained. Note that, the spiral operation is used for generating a continuous rugged shape on an exterior surface of a hollow container in an arbitrary range of an axial direction. First, it is determined which part of the bottle 30 is subjected to a spiral operation (S501). As is different from a deformable operation, the spiral operation will be performed upon the exterior of the bottle 30 in the circumference direction, which will require a selection of a axial directional area 65a as shown in FIG. 24. That is, the area where the spiral operation is performed is the entire area in the circumference direction between the upper limit and the lower limit of the exterior of the body, where is designated by the area 65a.

Next, it is selected and inputted as a spiral type what shape of spiral is provided, and parameters required for each spiral type are inputted (S502). In a spiral type shown in FIG. 25, a portion 62 and a portion 63 of a bottle 60 have cross-sections of a chrysanthemum shape as shown in FIG. 25(b), and the chrysanthemum shape flows in a spiral. For the chrysanthemum shape, it is required to input the number of partitions, a twist degree, the depth of ruggedness, the root radius of the rugged shape, or the like as the parameters. Other spiral types can be a V-groove and the like. For the V-groove shape, it is required to input the number of partitions, a twist degree, a groove width, a groove depth, the radius of curvature of an angled portion, the root radius of the V-groove or the like. The twist degree can be zero.

These parameters are appropriately modified (S504, S506) while looking at a preview indication (SSO5). When the parameters are ready for decision and application (S507), the solid model editing means 17 will perform a spiral operation to the solid model (S508). Then, as shown in FIG. 25, Spiral shapes will be formed as the shapes flowing between the upper limit and the lower limit of the body of the bottle 60 as mentioned above,

By subjecting a solid model to a secondary processing by using a spiral operation, a continuous rugged shape is generated on an exterior surface of a hollow container in an arbitrary range of an axial direction, thus easily designing a varied outer shape.

Note that, in the container designing system 1 shown in the present embodiment, the parametric inputting means 15, the solid model defining means 16, the solid model editing means 17 and the like are formed by a program operating on a CPU 10 of the computer body 4, and their functions are implemented thereby. That is to say, it is certain that the substance of the parametric inputting means 15, the solid model defining means 16, the solid model editing means 17 and the like are the program itself. Meanwhile, a program has a property capable of being circulated through a telecommunication line such as an LAN, the Internet or the like, in addition, there is the case where the program is dealt in a form of a computer-accessible recording medium recorded the program. An example of the recording medium can be a flexible disk, a CD-ROM, an MO or the like.

Finally, according to the container designing system 1 of the present embodiment, since an outer shape of the bottle 30 is defined as a solid model, when previewing the bottle 30 on the displaying apparatus 7 connected to the computer body 4, it is possible to faithfully reproduce the bottle 30 with a smoothed outer shape of representation.

Also, since a three-dimensional outer shape of the bottle 30 is defined as a solid model filled up with contents, it is possible to perform a high-speed calculation of a container capacity, a center of gravity, a tipping angle or the like without treating the interior of the bottle 30.

Moreover, since the shape conditions are inputted upon being parametrically defined, it is possible to quantitatively determine the shape of the bottle 30, and when inputting a rough outer shape, the inputting operation is easier than that of the wire frame model.

Moreover, by subjecting the solid model to a secondary processing after defining the outer shape of the bottle 30 as a solid model, an opening portion closing treatment required in a surface model after a Boolean operation as a secondary processing, is not required, thus performing an effective and high-speed secondary processing of the outer shape.

Moreover, since an outer shape is subjected to a secondary processing under the condition that the shape of the finish portion 31 of the bottle 30 is fixed, there is no case where the shape of the finish portion 31 is automatically altered by the secondary processing. Owing to this, it is possible to perform a secondary processing to the outer shape without paying attention to the predetermined shape of the finish portion 31, thus improving the operationability of the secondary processing.

Note that, although the present embodiment is explained in regard to a round bottle, it is not limited to the round bottle. For example, it is possible to perform a secondary processing upon defining a non-round bottle (square bottle, oval bottle or the like) as a solid model.

1. A container designing system using a computer for designing a shape of a hollow container, comprising:
a parametric inputting means for inputting a parametrically defined shape condition;
a storing means for storing said shape condition;
a solid model defining means for defining a three-dimensional outer shape of said hollow container as a solid model filled up with contents on the basis of said shape condition; and
a solid model editing means for subjecting said solid model to a secondary processing

2. A container designing system as set forth in claim 1 wherein said solid model is subjected to a secondary processing after an outer shape of said hollow container is defined as a solid model.

3. A container designing system as set forth in claim 1, wherein said solid model editing means subjects said solid model to a secondary processing by using a Boolean operation for altering a shape upon calculating a logical sum (OR), a logical difference (XOR) or a logical product (AND) of two shapes.

4. A container designing system as set forth in claim 1, wherein said solid model editing means subjects said solid model to a secondary processing by using a fillet operation for smoothly rounding an intersecting portion of one plane with the other plane.

5. A container designing system as set forth in claim 1, wherein said solid model editing means subjects said solid model to a secondary processing by using a deformable operation for altering a plane such that a positive load or a negative load is applied to the plane.

6. A container designing system as set forth in claim 1, wherein said solid model editing means subjects said solid model to a secondary processing by using a spiral operation for generating a continuous rugged shape on an exterior surface of said hollow container in an arbitrary range of an axial direction.

7. A container designing system as set forth in claim 1, further comprising a capacity modulating means for performing a shape modulation upon said outer shape in order that a container capacity after a shape modulation has a capacity determined by said shape condition.

8. A container designing system as set forth in claim 1, wherein it is possible to subject said outer shape to a secondary processing under the condition that a shape of a finish portion of said hollow container is fixed.

9. A container designing system as set forth in claim 7, wherein it is possible to perform said shape modulation upon said outer shape under the condition that a shape of a finish portion of said hollow container is fixed.

10. A container designing method using a computer for designing a shape of a hollow container, wherein a parametrically defined shape condition is inputted and a three-dimensional outer shape of said hollow container is defined as a solid model filled up with contents on the basis of said shape condition, after that, said solid model is subjected to a secondary processing.

11. A container designing method as set forth in claim 10, wherein said solid model is subjected to a secondary processing by using a Boolean operation for altering a shape upon calculating a logical sum (OR), a logical difference (XOR) or a logical product (AND) of two shapes.

12. A container designing method as set forth in claim 10, wherein said solid model is subjected to a secondary processing by using a fillet operation for smoothly rounding an intersecting portion of one plane with the other plane.

13. A container designing method as set forth in claim 10, wherein said solid model is subjected to a secondary processing by using a deformable operation for altering a plane such that a positive load or a negative load is applied to the plane.

14. A container designing method as set forth in claim 10, wherein said solid model is subjected to a secondary processing by using a spiral operation for generating a continuous rugged shape on an exterior surface of said hollow container in an arbitrary range of an axial direction.

15. A container designing method as set forth in claim 10, wherein a shape modulation upon said outer shape is performed in order that a container capacity after a shape modulation has a capacity determined by said shape condition.

16. A container designing method as set forth in claim 10, wherein it is possible to subject said outer shape to a secondary processing under the condition that a shape of a finish portion of said hollow container is fixed.

17. A container designing method as set forth in claim 15, wherein it is possible to perform said shape modulation upon said outer shape under the condition that a shape of a finish portion of said hollow container is fixed.

18. A container designing program for carrying out by a computer:
a parametric inputting means for inputting a parametrically defined shape condition;
a storing means for storing said shape condition;
a solid model defining means for defining a three-dimensional outer shape of a hollow container as a solid model filled up with contents on the basis of said shape condition; and
a solid model editing means for subjecting said solid model to a secondary processing.

19. A container designing program as set forth in claim 18, wherein said solid model is subjected to a secondary processing after an outer shape of said hollow container is defined as a solid model.

20. A container designing program as set forth in claim 18, wherein said solid model editing means subjects said solid model to a secondary processing by using a Boolean operation for altering a shape upon calculating a logical sum (OR), a logical difference (XOR) or a logical product (AND) of two shapes.

21. A container designing program as set forth in claim 18, wherein said solid model editing means subjects said solid model to a secondary processing by using a fillet operation for smoothly rounding an intersecting portion of one plane with the other plane.

22. A container designing program as set forth in claim 18, wherein said solid model editing means subjects said solid model to a secondary processing by using a deformable operation for altering a plane such that a positive load or a negative load is applied to the plane.

23. A container designing program as set forth in claim 18, wherein said solid model editing means subjects said solid model to a secondary processing by using a spiral operation for generating a continuous rugged shape on an exterior surface of said hollow container in an arbitrary range of an axial direction.

24. A container designing program as set forth in claim 18, wherein a capacity modulating means is comprised for performing a shape modulation upon said outer shape in order that a container capacity after a shape modulation has a capacity determined by said shape condition.

25. A container designing program as set forth in claim 18, wherein it is possible to subject said outer shape to a secondary processing under the condition that a shape of a finish portion of said hollow container is fixed.

26. A container designing program as set forth in claim 24, wherein it is possible to perform said shape modulation upon said outer shape under the condition that a shape of a finish portion of said hollow container is fixed.

27. A computer-accessible recording medium recording a container designing program for carrying out by a computer:
a parametric inputting means for inputting a parametrically defined shape condition;
a storing means for storing said shape condition;
a solid model defining means for defining a three-dimensional outer shape of a hollow container as a solid model filled up with contents on the basis of said shape condition; and
a solid model editing means for subjecting said solid model to a secondary processing.

28. A computer-accessible recording medium recording a container designing program as set forth in claim 27, wherein said solid model is subjected to a secondary processing after an outer shape of said hollow container is defined as a solid model.

29. A computer-accessible recording medium recording a container designing program as set forth in claim 27, wherein said solid model editing means subjects said solid model to a secondary processing by using a Boolean operation for altering a shape upon calculating a logical sum (OR), a logical difference (XOR) or a logical product (AND) of two shapes.

30. A computer-accessible recording medium recording a container designing program as set forth in claim 27, wherein said solid model editing means subjects said solid model to a secondary processing by using a fillet operation for smoothly rounding an intersecting portion of one plane with the other plane.

31. A computer-accessible recording medium recording a container designing program as set forth in claim 27, wherein said solid model editing means subjects said solid model to a secondary processing by using a deformable operation for altering a plane such that a positive load or a negative load is applied to the plane.

32. A computer-accessible recording medium recording a container designing program as set forth in claim 27, wherein said solid model editing means subjects said solid model to a secondary processing by using a spiral operation for generating a continuous rugged shape on an exterior surface on said hollow container in an arbitrary range of an axial direction.

33. A computer-accessible recording medium recording a container designing program as set forth in claim 27, wherein a capacity modulating means is comprised for performing a shape modulation upon said outer shape in order that a container capacity after a shape modulation has a capacity determined by said shape condition.

34. A computer-accessible recording medium recording a container designing program as set forth in claim 27, wherein it is possible to subject said outer shape to a secondary processing under the condition that a shape of a finish portion of said hollow container is fixed.

35. A computer-accessible recording medium recording a container designing program as set forth in claim 33, wherein it is possible to perform said shape modulation upon said outer shape under the condition that a shape of a finish portion of said hollow container is fixed.
